(19) United States
(12) Patent Application Publication
(10) Pub. No.: US 2018/0090028 A1
(43) Pub. Date: Mar. 29, 2018

(54) Demonstration Generator

(71) Applicant: Tobi Lee, Bellevue, WA (US)

(72) Inventor: Tobi Lee, Bellevue, WA (US)

(21) Appl. No.: 15/275,424

(22) Filed: Sep. 25, 2016

(51) Int. Cl. G09B 23/18

(52) U.S. Cl. CPC G09B 23/188

(57) ABSTRACT

A demonstration generator may be used to illustrate electrical generation. A The demonstration generator may be based on a spinning top, a yo-yo, a gyroscope, or other spinning devices. A demonstration generator may allow an electrical current to be generated via induction by using a spinning motion to move one or more magnets relative to one or more coils.

### FIELD

This disclosure generally relates to a demonstration generator.

### BACKGROUND

Various techniques are used in classrooms to teach electrical power generation. Electricity may be generated from the physical separation and transport of a charge, induction, or from kinetic energy, for example. However, tools used to demonstrate electrical generation are often difficult for students to see or difficult for instructors to use.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a demonstration generator which may be used to illustrate electrical generation. A demonstration generator may be a spinning top, a yo-yo, or a gyroscope, for example. A yo-yo demonstration generator may consist of an axle connected to two disks, and a string wrapped around the axle, resembling a conventional yo-yo. Another example of a demonstration generator may be a gyroscope, consisting of a wheel mounted on an axle, where the wheel and axle spin freely while secured in a frame. The rotor of a gyroscope may be spun using a string or manually. One having skill in the art will recognize that many different shapes may be used for a demonstration generator.

A demonstration generator shaped like a top may have a magnet or a set of magnets fixed to the edges of the broad width of the top, with the poles perpendicular to an axis of spin. Each magnet may create a magnetic field, which may be configured perpendicular to a spin axis of a spinning top, for example. A spinning top may sit on a centering surface made of non-magnetic, non-conductive material with a concave surface where demonstration generator may spin. The centering surface may have an embedded coil of electrically conductive wire. The greater the flux density of the magnet, and the more wraps on the coil, the more powerful the electric current may be.

In a yo-yo-based demonstration generator, a coil may be embedded in a mount, or otherwise located in a position allowing the yo-yo to be snapped down and spun in place in close proximity to the coil. In another embodiment, the axle may allow one side to spin independently of the other. One side may have a coil, while the other side provides a magnetic field.

A demonstration generator may resemble a gyroscope. Here, the conductor may be inside a frame that surrounds a rotor, or it may be inside a mount, such as a stationary surface with an embedded coil of electricity conducting wire. This may also serve as a portable electric generator.

The spin velocity, magnetic flux density, and wire size and number of wraps of a coil may all affect the output of electric current produced by a demonstration generator. A demonstration generator may generate sufficient electric current to power an electrical sink. Examples of electric sinks are light bulbs, LEDs, and buzzers. A demonstration generator may be used as an independent electricity generator or as a tool for teaching complex laws of the electromagnetic induction process and the flow of electric current.

### BRIEF DESCRIPTION OF THE DRAWINGS

FIG. 1 illustrates a view of a spinning top demonstration generator according to one embodiment.

FIG. 2 illustrates a view of a spinning top demonstration generator according to another embodiment.

FIG. 3 illustrates a view of a yo-yo demonstration generator according to one embodiment.

FIG. 4 illustrates a view of a gyroscope demonstration generator according to one embodiment.

FIG. 5 illustrates a view of a gyroscope demonstration generator according to another embodiment.

### DETAILED DESCRIPTION

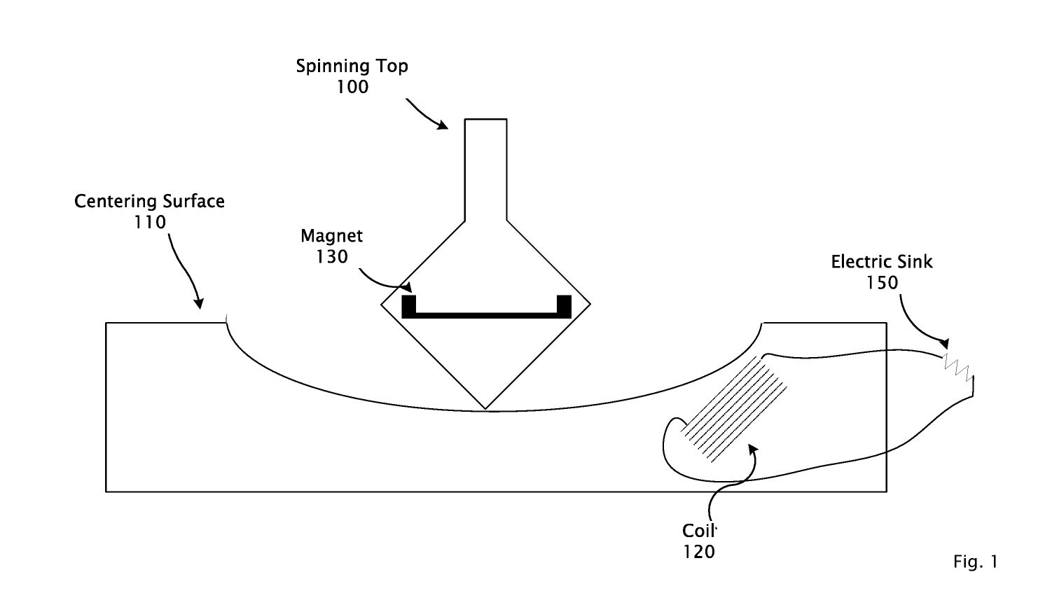

FIG. 1 illustrates a view of demonstration generator according to one embodiment. Spinning Top 100 may have a narrow handle on top and narrow to a point at the bottom. One or more Magnets 130 may be fixed to Spinning Top 100. Magnet 130 may have magnetic lines of force which create a magnetic field. Magnet 130 may have north and south poles aligned perpendicular to a spin axis of Spinning Top 100. Spinning Top 100 may sit on Centering Surface 110. Centering Surface 110 may have a concave surface, which may keep Spinning Top 100 near Coil 120, and may be made of non-magnetic material. Coil 120 may be made of electrically conductive wire.

Rotating Spinning Top 100 in a proper orientation and in close proximity of Coil 120 may induce an electrical current in Coil 120. The electrical current may be sufficient to provide electricity to an Electrical Sink 150, which may be, for example, a buzzer, an incandescent light bulb, an LED, a calculator, or other objects operable by electricity. The current flow generated may be alternating current (AC), switching directions as the north and south magnet poles move past Coil 120. A rectifier may be used to provide direct current (DC). Alternatively, multiple LEDs may be coupled in parallel with different polarity, so that at least one is lit when the current flows in one direction, and at least one is lit when the current is reversed.

Current flow may depend on how densely Coil 120 is wrapped and the strength of the magnetic fields from Magnet 130 for Coil 120. The closer Magnet 130, and more densely wrapped Coil 120, the greater the electric current may be.

As current increases, induced magnetism may increase, which may then cause Spinning Top 100 to become unstable. To counter this effect, additional rotating mass may be used for Spinning Top 100. Making sections of Spinning Top 100 from, for example, steel, copper, or other denser materials rather than plastic, aluminum, or other light materials may help reduce instability issues. For example, making a portion of Spinning Top 100 out of materials with higher densities, 7.85 g/cm³ for mild steel or 8.96 7.85 g/cm³, for example, may allow Spinning Top 100 to remain more stable than making it out of aluminum, which may have a density of 2.7 g/cm³.

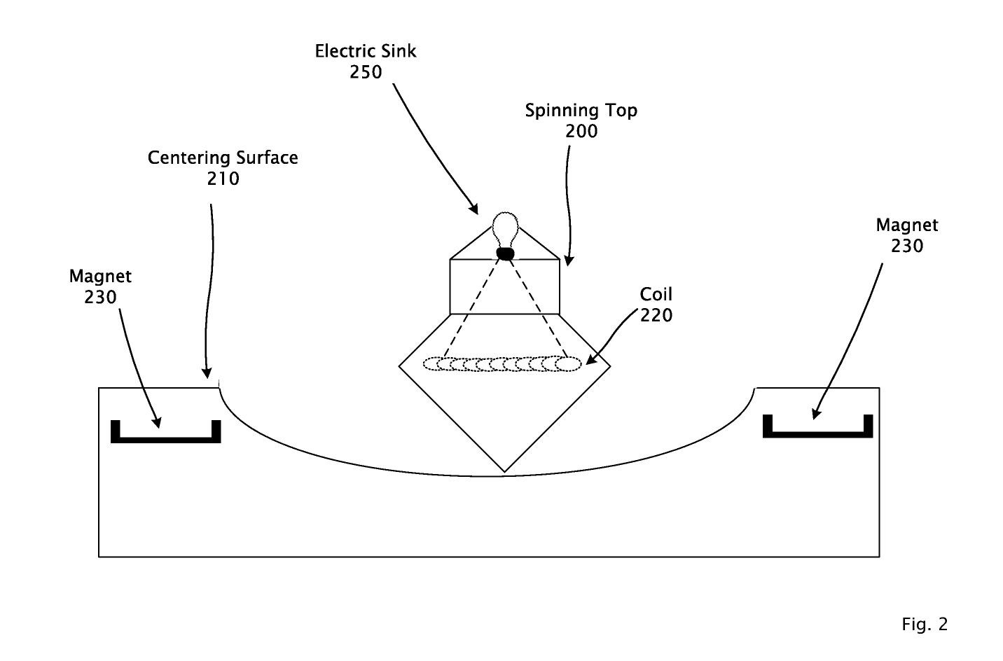

FIG. 2 illustrates a view of a demonstration generator according to another embodiment. Coil 220 and Electric Sink 250 may be attached to or embedded within Spinning Top 200. Magnet 230 may be one or more magnets, with north poles of each facing the same direction. Magnet 230 may be attached to or embedded to Centering Surface 210. Spinning Top 200 may spin on Centering Surface 210 made of non-magnetic material. Electricity generated by demonstration generator may be captured using a conductor, such as Coil 120 which may be made of electricity conducting wire. Magnet 230 may have north and south poles aligned perpendicular to a spin axis of Spinning Top 200. Spinning Top 200 may sit on Centering Surface 210. Centering Surface 210 may have a concave surface, which may keep Spinning Top 200 near Magnet 230, and may be made of non-magnetic material.

Rotating Spinning Top 200 in a proper orientation and in close proximity of Magnet 230 may induce an electrical current in Coil 220. The electrical current may be sufficient to provide electricity to an Electrical Sink 250, which may be, for example, a buzzer, an incandescent light bulb, an LED, a calculator, or other objects operable by electricity.

Current flow may depend on how densely Coil 220 is wrapped and the strength of the magnetic fields from Magnet 230 for Coil 220. The closer Magnet 230, and more densely wrapped Coil 220, the greater the electric current may be.

As current increases, induced magnetism may increase, which may then cause Spinning Top 200 to become unstable. To counter this effect, additional rotating mass may be used for Spinning Top 200. Making sections of Spinning Top 200 from, for example, steel, copper, or other denser materials rather than plastic, aluminum, or other light materials may help reduce instability issues.

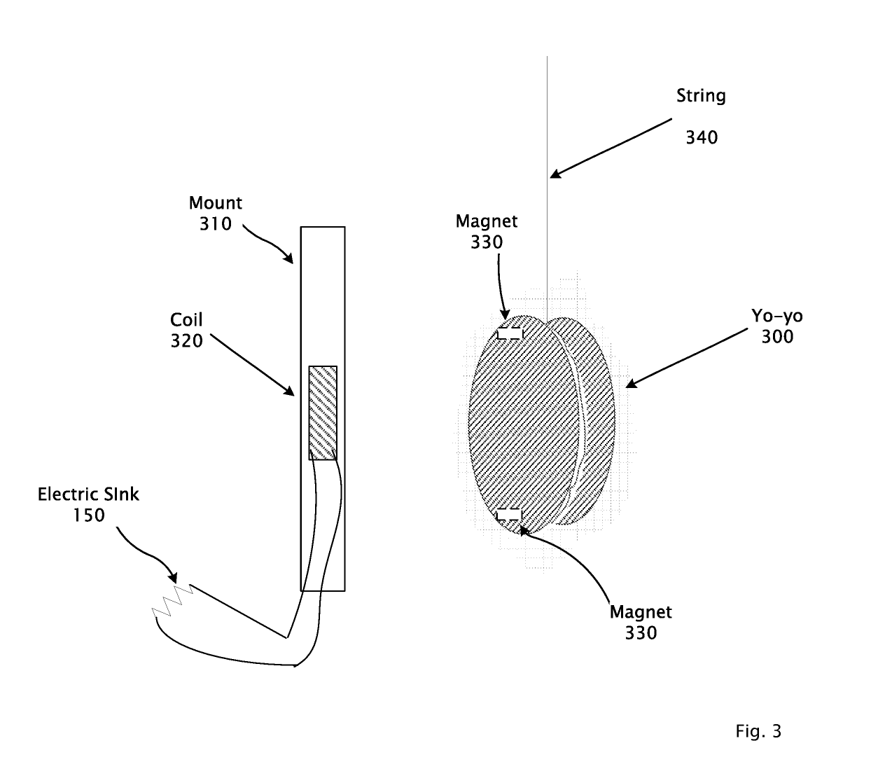

FIG. 3 illustrates a view of a demonstration generator according to another embodiment, Yo-Yo 300 may consist of an axle connected to two disks, and String 340 wrapped around the axle. Yo-Yo 300 may be spun by holding a free end of String 340, inserting a finger into a slip knot, allowing gravity or a force of a throw to spin Yo-Yo 300 and unwind String 340. Mount 310 may be located where Yo-Yo 300 is snapped down and spun. This close proximity may allow Coil 320, which may be exposed or embedded in Mount 310, to capture electricity generated by Yo-Yo 300. Magnet 330 may be one or more magnets, with north poles of each facing the same direction. While spinning Yo-Yo 300 in a proper orientation and in close proximity of Coil 320, electromagnetic induction may occur. Coil 320 may be placed in various places near Yo-Yo 300.

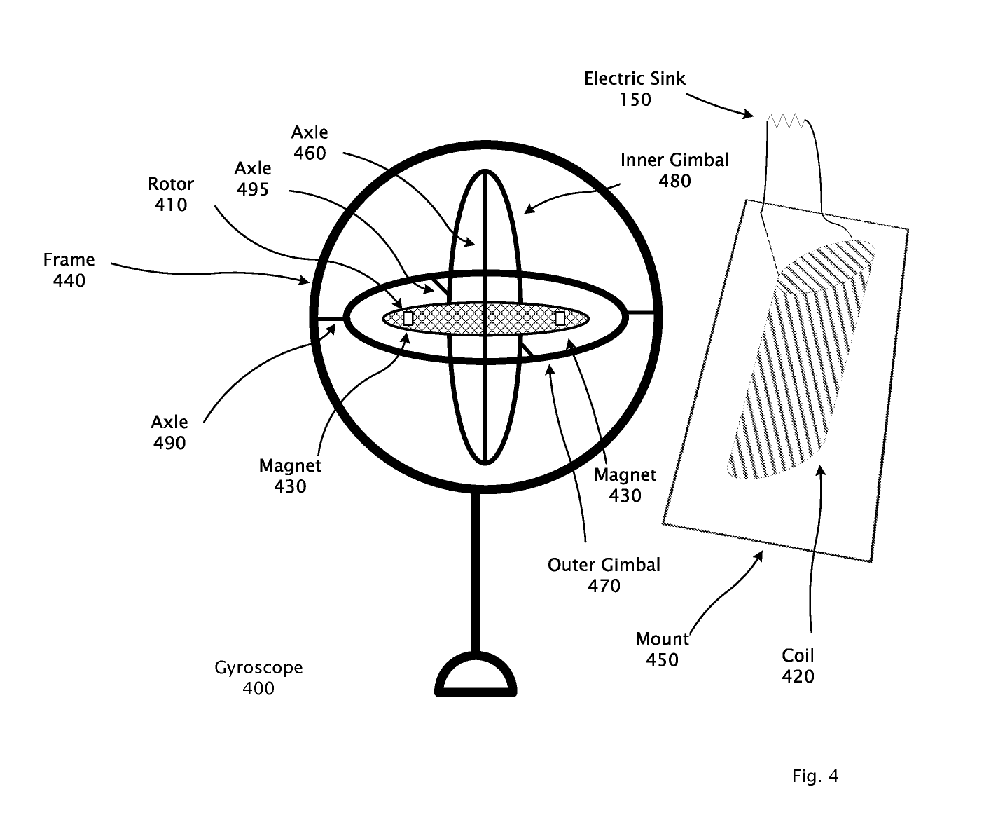

FIG. 4 illustrates a view of a demonstration generator according to yet another embodiment. Gyroscope 400 may consist of Rotor 410 mounted on Axle 460, where Rotor 410 and Axle 460 may spin freely while secured in Frame 440. Magnet 430 may be one or more magnets, with north poles of each facing the same direction. Rotor 410 of Gyroscope 400 may be spun using a string or manually. A Mount 450 may be placed outside Gyroscope 400 or Coil 420 may be embedded within Gyroscope 400. Outer Gimbal 470 may be a ring which may be mounted on Frame 440 so as to rotate about Axle 490. Inner Gimbal 480 may be mounted perpendicular to Outer Gimbal 470 and may rotate about Axle 495.

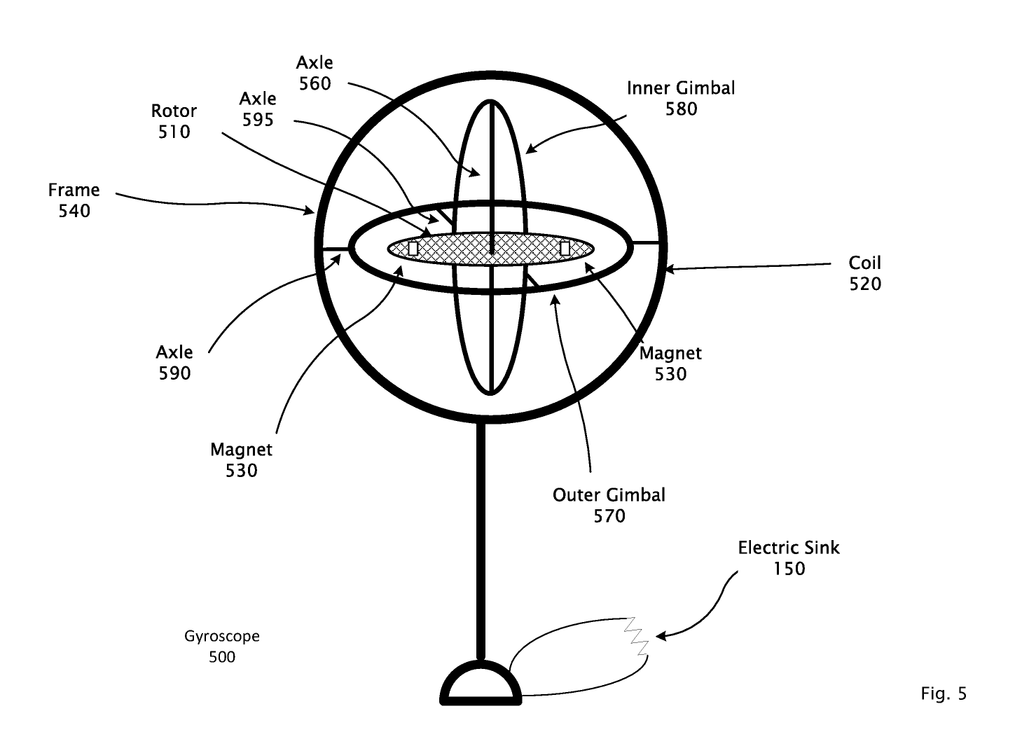

FIG. 5 illustrates a view of a demonstration generator according to yet another embodiment, Gyroscope 500. Coil 520 may be inside Frame 540 that surrounds Rotor 510, which may spin in any orientation about Axle 560. Magnet 530 may be embedded in Rotor 510, or may be attached externally, using adhesive or a mechanical fastener, for example. Outer Gimbal 570 may be a ring which may be mounted on Frame 540, and may rotate about Axle 590. Inner Gimbal 580 may be mounted to Outer Gimbal 570 and may rotate about Axle 595, perpendicular to Outer Gimbal 570. Gyroscope 500 may be used as a portable electric generator.

Regardless of the type of demonstration generator, the velocity of the spin must be sufficient to generate an electric current so it may be enough to power Electric Sink 150, which may be, for example, a buzzer, an incandescent light bulb, an LED, a calculator, or other objects operable by electricity. Spin velocity, magnetic flux density, and coil density may affect the strength of the electric current.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A generator, comprising:
a magnet, the magnet coupled to a spinning top;
a centering surface, operable to center the spinning top above a coil, the coil embedded in the centering surface; and
an electric sink, operably coupled to the coil.

2. The generator of claim 1, wherein at least a portion of the spinning top is made from material having a density of at least 5 g/cm³.

3. The generator of claim 1, wherein the magnet is embedded in the spinning top.

4. The generator of claim 1, wherein the magnet is adhesively attached to the spinning top.

5. A generator, comprising:
a gyroscope comprising a rotor;
a magnet coupled to the rotor; and
a coil positioned to allow a magnetic field of the magnet to move relative to the coil.

6. The generator of claim 5, wherein the coil is disposed within a mount external to the gyroscope.

7. The generator of claim 5, wherein the coil is disposed within a frame of the gyroscope.

8. A generator, comprising:
a yo-yo, comprising two disks coupled with an axle;
a magnet coupled to one of the disks;
a coil positioned to allow a magnetic field of the magnet to move relative to the coil; and
an electrical sink, operably coupled to the coil.
